(19) United States
(12) Patent Application Publication
(10) Pub. No.: US 2023/0383429 A1
(43) Pub. Date: Nov. 30, 2023

(54) CARBON DIOXIDE RECOVERY SYSTEM

(71) Applicant: DENSO CORPORATION, Kariya-city (JP)

(72) Inventors: Hiroki TAKEZAKI, Kariya-city (JP); Hiroaki UMEDA, Kariya-city (JP); Hironori TATSUMI, Kariya-city (JP)

(21) Appl. No.: 18/321,060

(22) Filed: May 22, 2023

(30) Foreign Application Priority Data
May 26, 2022 (JP) 2022-086278

(51) Int. Cl. C25B 15/08; B01J 20/20; B01J 20/34

(52) U.S. Cl. CPC C25B 15/085; B01J 2220/4812; B01J 20/3483; B01J 20/20

(57) ABSTRACT

A carbon dioxide recovery system includes an electrochemical cell. The electrochemical cell includes a working electrode, a counter electrode, and an electrolytic solution. The working electrode includes a CO₂ adsorbent. The working electrode and the counter electrode are disposed to sandwich the electrolytic solution therebetween. The CO₂ adsorbent is configured to absorb CO₂ in response to a voltage being applied between the working electrode and the counter electrode and electrons being supplied from the counter electrode to the working electrode. The CO₂ adsorbent is a porous body having pores, and a pore diameter of the pores is larger than an ion diameter of the electrolytic solution.

### CROSS REFERENCE TO RELATED APPLICATION

The present application claims the benefit of priority from Japanese Patent Application No. 2022-086278 filed on May 26, 2022. The entire disclosure of the above application is incorporated herein by reference.

### TECHNICAL FIELD

The present disclosure relates to a carbon dioxide recovery system.

### BACKGROUND

Methods for separating carbon dioxide (CO₂) from a CO₂ containing gas by an electrochemical reaction have been known.

### SUMMARY

The present disclosure provides a carbon dioxide recovery system including an electrochemical cell. The electrochemical cell includes a working electrode, a counter electrode, and an electrolytic solution. The working electrode includes a CO₂ adsorbent. The working electrode and the counter electrode are disposed to sandwich the electrolytic solution therebetween. The CO₂ adsorbent is configured to absorb CO₂ in response to a voltage being applied between the working electrode and the counter electrode and electrons being supplied from the counter electrode to the working electrode. The CO₂ adsorbent is a porous body having pores, and a pore diameter of the pores is larger than an ion diameter of the electrolytic solution.

### BRIEF DESCRIPTION OF DRAWINGS

Objects, features and advantages of the present disclosure will become apparent from the following detailed description made with reference to the accompanying drawings. In the drawings:

FIG. 1 is a diagram illustrating a carbon dioxide recovery system of a first embodiment;

FIG. 2 is a diagram illustrating a CO₂ recovery device;

FIG. 3 is a cross-sectional view of an electrochemical cell;

FIGS. 4A to 4H are diagrams showing cations and anions contained in an ionic liquid used as an electrolytic solution;

FIG. 5 is a diagram illustrating a pore diameter distribution of a CO₂ adsorbent;

FIG. 6 is a diagram schematically illustrating a pore structure of the CO₂ adsorbent;

FIG. 7A is a diagram for explaining a CO₂ recovery mode of the CO₂ recovery device; and

FIG. 7B is a diagram for explaining a CO₂ discharge mode of the CO₂ recovery device.

### DETAILED DESCRIPTION

Next, a relevant technology is described only for understanding the following embodiments. There is a method of separating CO₂ from a CO₂ containing gas by an electrochemical reaction. In this method, the CO₂ containing gas is supplied to a cathode of an electrochemical cell while a potential difference is applied between the cathode and an anode, so that an electrochemical reaction in which CO₃²⁻ is produced from CO₂ and an electrochemical reaction in which CO₂ is produced from CO₃²⁻ are performed.

However, when there are few voids in a working electrode member of the electrochemical cell, the CO₂ containing gas and electrolyte ions do not sufficiently diffuse into the working electrode member. As a result, in the working electrode member, the ratio of effective active sites capable of adsorbing CO₂ decreases, and the CO₂ recovery efficiency decreases.

A carbon dioxide recovery system according to an aspect of the present disclosure is configured to separate CO₂ from a CO₂ containing gas by an electrochemical reaction, and includes an electrochemical cell. The electrochemical cell includes a working electrode, a counter electrode, and an electrolytic solution. The working electrode includes a CO₂ adsorbent. The working electrode and the counter electrode are disposed to sandwich the electrolytic solution therebetween. The CO₂ adsorbent is configured to absorb CO₂ in response to a voltage being applied between the working electrode and the counter electrode and electrons being supplied from the counter electrode to the working electrode. The CO₂ adsorbent is a porous body having pores, and a pore diameter of the pores is larger than an ion diameter of the electrolytic solution.

Accordingly, O₂, CO₂, and ions of the electrolytic solution can be sufficiently diffused into the pores of the CO₂ adsorbent. Therefore, the ratio of effective active sites in the CO₂ adsorbent can be increased, and the CO₂ recovery efficiency can be improved.

The following will describe embodiments for carrying out the present disclosure with reference to the drawings. In each embodiment, portions corresponding to the elements described in the preceding embodiments are denoted by the same reference numerals, and redundant explanation may be omitted. When only a part of a configuration is described in an embodiment, another preceding embodiment may be applied to the other parts of the configuration. In addition to the combinations of parts specifically shown in the respective embodiments, the embodiments can be partly combined even if not explicitly suggested, unless such combinations are contradictory.

### First Embodiment

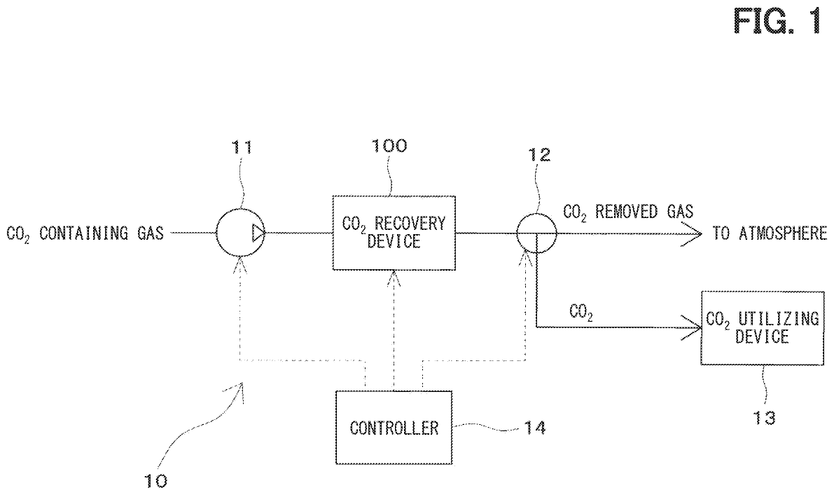

The following describes a first embodiment of the present disclosure with reference to the drawings. As shown in FIG. 1, a carbon dioxide recovery system 10 of the present embodiment includes a compressor 11, a CO₂ recovery device 100, a passage switching valve 12, a CO₂ utilizing device 13, and a controller 14.

The compressor 11 pumps CO₂ containing gas to the CO₂ recovery device 100. The CO₂ containing gas is a mixed gas containing CO₂ and a gas other than CO₂, and for example, the atmosphere can be used as the CO₂ containing gas. The CO₂ containing gas contains at least O₂ as the gas other than CO₂.

The CO₂ recovery device 100 is a device that separates CO₂ from the CO₂ containing gas and recovers CO₂. The CO₂ recovery device 100 discharges a CO₂ removed gas that is gas after CO₂ is recovered from the CO₂ containing gas, or CO₂ that is recovered from the CO₂ containing gas. The configuration of the CO₂ recovery device 100 will be described in detail later.

The passage switching valve 12 is a three-way valve that switches a passage of exhaust gas from the CO₂ recovery device 100. The passage switching valve 12 switches the passage of the exhaust gas toward the atmosphere when the CO₂ removed gas is discharged from the CO₂ recovery device 100, and switches the passage of the exhaust gas toward the CO₂ utilizing device 13 when CO₂ is discharged from the CO₂ recovery device 100.

The CO₂ utilizing device 13 is a device that utilizes CO₂. The CO₂ utilizing device 13 may be a storage tank for storing CO₂ or a conversion device for converting CO₂ into fuel. As the conversion device, a device that converts CO₂ into a hydrocarbon fuel such as methane can be used. The hydrocarbon fuel may be gaseous fuel at normal temperature and pressure, or may be liquid fuel at normal temperature and pressure.

The controller 14 includes a well-known microcontroller including a calculation processing device (CPU), a read only memory (ROM), a random access memory (RAM) and the like, and peripheral circuits thereof. The controller 14 performs various calculations and processes based on control programs stored in the ROM, and controls actuations of various devices connected to an output side of the controller 14. The controller 14 of the present embodiment performs an operation control of the compressor 11, an operation control of the CO₂ recovery device 100, a passage switching control of the passage switching valve 12 and the like.

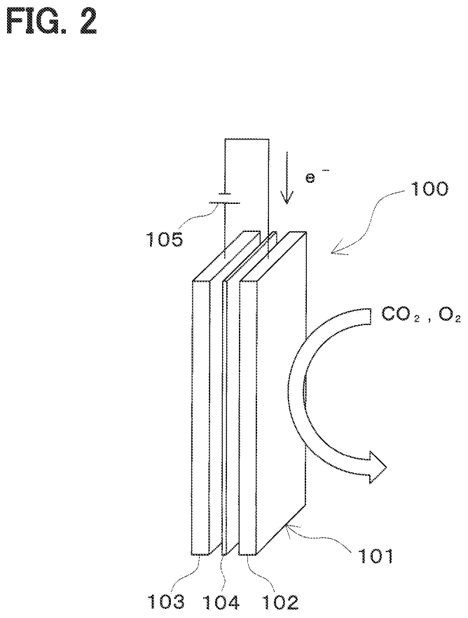

Next, the CO₂ recovery device 100 will be described with reference to FIG. 2. As shown in FIG. 2, the CO₂ recovery device 100 includes an electrochemical cell 101. The electrochemical cell 101 includes a working electrode 102, a counter electrode 103 and an insulating layer 104. In the example shown in FIG. 2, the working electrode 102, the counter electrode 103 and the insulating layer 104 are each formed in a plate shape. In FIG. 2, the working electrode 102, the counter electrode 103 and the insulating layer 104 are illustrated to have distances therebetween, but actually, these components are arranged to be in contact with each other.

The electrochemical cell 101 may be housed in a container (not shown). The container may define a gas inlet for introducing the CO₂ containing gas into the container and a gas outlet for discharging the CO₂ removed gas and CO₂ out of the container.

The CO₂ recovery device 100 is configured to adsorb and desorb CO₂ by electrochemical reactions, thereby separating and recovering CO₂ from the CO₂ containing gas. The CO₂ recovery device 100 includes a power supply 105 that applies a predetermined voltage to the working electrode 102 and the counter electrode 103, and can change a potential difference between the working electrode 102 and the counter electrode 103. The working electrode 102 is a negative electrode, and the counter electrode 103 is a positive electrode.

The electrochemical cell 101 can be switched between a CO₂ recovery mode in which CO₂ is recovered at the working electrode 102 and a CO₂ discharge mode in which CO₂ is discharged from the working electrode 102 by changing the potential difference between the working electrode 102 and the counter electrode 103. The CO₂ recovery mode is a charging mode for charging the electrochemical cell 101, and the CO₂ discharge mode is a discharging mode for discharging the electrochemical cell 101.

In the CO₂ recovery mode, a first voltage V1 is applied between the working electrode 102 and the counter electrode 103, and electrons flow from the counter electrode 103 to the working electrode 102. At the first voltage V1, the counter electrode potential is greater than the working electrode potential. The first voltage V1 may fall within a range between 0.5 and 2.0 V.

In the CO₂ discharge mode, a second voltage V2 is applied between the working electrode 102 and the counter electrode 103, and electrons flow from the working electrode 102 to the counter electrode 103. The second voltage V2 is a voltage lower than the first voltage V1, and a magnitude relationship between the working electrode potential and the counter electrode potential is not limited. That is, in the CO₂ discharge mode, the working electrode potential may be lower than, equal to, or greater than the counter electrode potential.

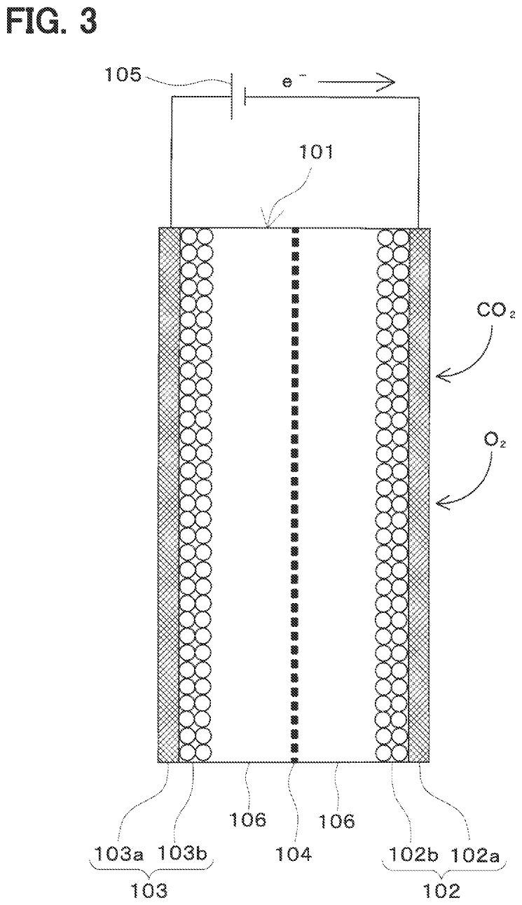

As shown in FIG. 3, the working electrode 102 is provided with a working-electrode current collector 102a and a CO₂ adsorbent 102b.

The working-electrode current collector 102a is a porous conductive material having pores through which gas containing CO₂ can pass. As the working-electrode current collector 102a, for example, a carbonaceous material or a metal porous body can be used. The carbonaceous material constituting the working-electrode current collector 102a may be, for example, carbon paper, carbon cloth, non-woven carbon mat, porous gas diffusion layer (GDL) and the like. The metal porous body constituting the working-electrode current collector 102a may be, for example, a metal mesh that is a metal (e.g., Al, Ni, and the like) formed into a mesh shape.

The CO₂ adsorbent 102b will be described in detail later.

The CO₂ adsorbent 102b is added with a binder. The binder is provided to hold the CO₂ adsorbent 102b on the working-electrode current collector 102a of the working electrode 102. The binder has an adhesive force and is provided between the CO₂ adsorbent 102b and the working-electrode current collector 102a.

The binder may be a conductive resin. The conductive resin may be, for example, an epoxy resin or a fluoropolymer, containing Ag or the like as a conductive filler. The fluoropolymer may be, for example, polytetrafluoroethylene (PTFE), or polyvinylidene fluoride (PVDF).

The binder can be brought into contact with the working-electrode current collector 102a provided with the CO₂ adsorbent 102b by using an organic solvent such as N-methylpyrrolidone (NMP). Alternatively, a raw material of the binder and the CO₂ adsorbent 102b may be dispersed and mixed using a homogenizer or the like, and then the mixture may be pressure-bonded to the working-electrode current collector 102a or spray-coated on the working-electrode current collector 102a.

The counter electrode 103 has a configuration similar to the working electrode 102, and is provided with a counter-electrode current collector 103a and a counter-electrode active material 103b. The counter-electrode current collector 103a may use the same conductive material as the working-electrode current collector 102a, or may use a different material.

The counter-electrode active material 103b is an electroactive species that receives and releases electrons by a redox reaction. The counter-electrode active material 103b may be, for example, a metal complex that can receive and release electrons by changing a valence of a metal ion. Examples of such metal complex include cyclopentadienyl metal complexes such as ferrocene, nickelocene and cobaltocene, and porphyrin metal complexes. In the present embodiment, polyvinyl ferrocene shown below is used as the counter-electrode active material 103b.

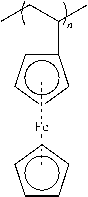

The counter-electrode active material 103b is added with a conductive material and a binder. The conductive material forms a conductive path to the counter-electrode active material 103b. The binder may be any material as long as it can hold the counter-electrode active material 103b on the counter-electrode current collector 103a and has conductivity. The conductive material of the counter electrode 103 may be, for example, a carbon material such as carbon nanotube, carbon black, or graphene. The binder of the counter electrode 103 may use the same material as the working electrode 102, or may use a different material.

The insulating layer 104 is arranged between the working electrode 102 and the counter electrode 103, and is a separator that separates the working electrode 102 and the counter electrode 103 from each other. The insulating layer 104 prevents physical contact between the working electrode 102 and the counter electrode 103 and electrically insulates the working electrode 102 and the counter electrode 103 from each other.

The insulating layer 104 has ion permeability. In the present embodiment, a porous material is used as the insulating layer 104. The insulating layer 104 may be, a cellulose membrane, a polymer, a composite material of a polymer and a ceramic, or the like.

In the electrochemical cell 101, the working electrode 102 and the counter electrode 103 are disposed to sandwich an electrolytic solution 106 therebetween. The electrolytic solution 106 is an ion conductive material provided between the working electrode 102 and the counter electrode 103. The electrolytic solution 106 is partitioned into a portion close to the working electrode 102 and a portion close to the counter electrode 103 by the insulating layer 104.

The electrolytic solution 106 may be, for example, an ionic liquid. The ionic liquid is a salt of a liquid having non-volatility under normal temperature and pressure. When the ionic liquid is used as the electrolytic solution 106, the ionic liquid may be gelled to prevent elution of the ionic liquid from the electrochemical cell 101.

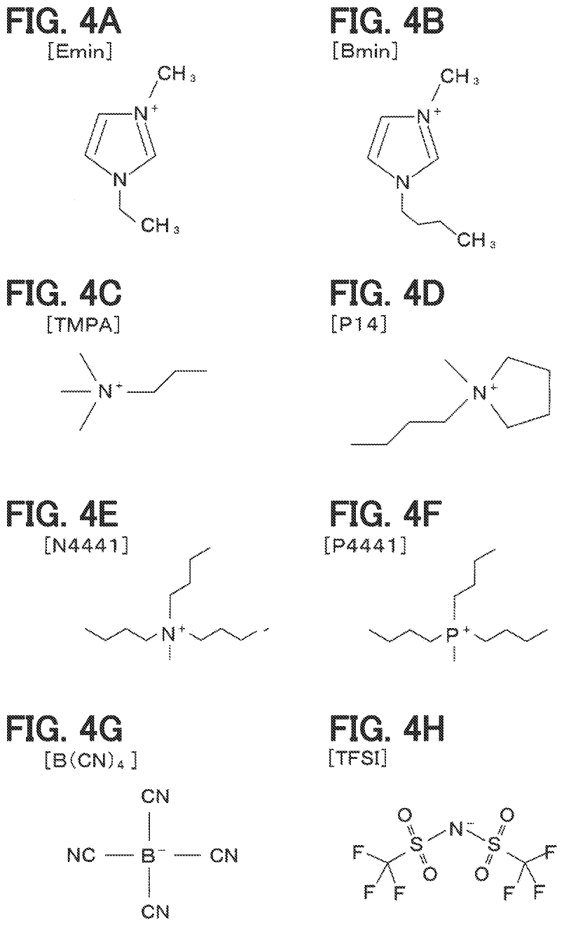

FIGS. 4A to 4H illustrate cations and anions contained in the ionic liquid used in the electrolytic solution 106 of the present embodiment. The ionic liquid used as the electrolytic solution 106 contains at least one cation selected from the group consisting of Emin shown in FIG. 4A, Bmin shown in FIG. 4B, TMPA shown in FIG. 4C, P14 shown in FIG. 4D, N4441 shown in FIG. 4E, and P4441 shown in FIG. 4F, and at least one anion selected from the group consisting of B(CN)₄ shown in FIG. 4G and TFSI shown in FIG. 4H.

Here, the CO₂ adsorbent 102b of the working electrode 102 will be described. The CO₂ adsorbent 102b adsorbs CO₂ by receiving electrons, and desorbs the adsorbed CO₂ by releasing electrons. The CO₂ adsorbent 102b is made of a material whose chemical skeleton does not change when adsorbing CO₂. In other words, the CO₂ adsorbent 102b does not have a chemical structure that serves as an active site for adsorbing CO₂.

In the present embodiment, the CO₂ adsorbent 102b is a made of material that can transfer electrons without changing its chemical skeleton when a negative potential is applied to the counter electrode 103. The CO₂ adsorbent 102b is made of a material in which, when receiving electrons from the counter electrode 103, the electric charge is delocalized in the entire material without concentrating on a specific element in its chemical structure.

When the first voltage V1 is applied between the working electrode 102 and the counter electrode 103, electrons flow from the counter electrode 103 to the working electrode 102, and the CO₂ adsorbent 102b takes in the electrons and adsorbs CO₂. When the second voltage V2 is applied between the working electrode 102 and the counter electrode 103, electrons flow from the working electrode 102 to the counter electrode 103, and the CO₂ adsorbent 102b discharges the electrons and desorbs CO₂.

In the CO₂ recovery mode, an oxygen reduction reaction shown in the following reaction formula (1) and a carbonate ion generation reaction shown in the following reaction formula (2) proceed at the working electrode 102, and CO₂ is adsorbed to the working electrode 102. In other words, the oxygen reduction reaction triggers the CO₂ adsorption at the working electrode 102.

O₂+2e⁻→O₂⁻ (1)

O₂⁻+CO₂→1/2O₂+CO₃²⁻ (2)

At the working electrode 102, O₂ contained in the CO₂ containing gas receives electrons and is reduced, thereby causing an oxygen reduction reaction. Superoxide O₂⁻, which is a type of active oxygen is formed by the oxygen reduction reaction. The active oxygen O₂⁻ formed by the oxygen reduction reaction has high reactivity, and a carbonate ion generation reaction is performed in which CO₂ is oxidized to from carbonate ions CO₃²⁻, which are oxide ions of CO₂, and CO₂ is adsorbed to the CO₂ adsorbent 102b. In other words, the active oxygen O₂⁻ formed by the oxygen reduction reaction contributes to CO₂ adsorption at the working electrode 102.

The CO₂ adsorbent 102b is a high specific surface area material having conductivity. The high specific surface area material is a porous body having a large number of pores. An opening shape and a cross-sectional shape of the pores of the high specific surface area material are not limited to a circular shape.

In the high specific surface area material, sites with which O₂, CO₂, and ions of the electrolytic solution 106 are in contact become effective active sites and CO₂ adsorption sites. In order to increase the ratio of effective active sites in the high specific surface area material and improve the CO₂ adsorption efficiency of the CO₂ adsorbent 102b, it is necessary for O₂, CO₂, and ions of the electrolytic solution 106 to sufficiently diffuse into the pores of the high specific surface area material.

Therefore, in the present embodiment, a high specific surface area material having a pore diameter larger than the molecular diameter of O₂, the molecular diameter of CO₂, and the ion diameter of the electrolytic solution 106 is used as the CO₂ adsorbent 102b. Since the ion diameter of the electrolytic solution 106 is larger than the molecular diameters of O₂ and CO₂, the high specific surface area material used as the CO₂ adsorbent 102b may have a pore diameter larger than the ion diameter of the electrolytic solution 106.

When the electrolytic solution 106 contains a plurality of types of ions having different sizes, the “ion diameter of the electrolytic solution” means the ion diameter of the largest ion. The pore diameter of the high specific surface area material can be measured by, for example, a gas adsorption method. In the gas adsorption method, the pore diameter distribution can be measured from the relationship between the pressure and the adsorption amount by measuring the adsorption amount while changing the pressure of the inert gas (N₂ or the like).

The molecular diameter of O₂ is 0.34 nm, and the molecular diameter of CO₂ is 0.46 nm. The ionic diameters of the cations and the anions of the ionic liquid shown in FIGS. 4A to 4H are about 1 to 3 nm. Therefore, in the present embodiment, a high specific surface area material having a pore diameter larger than 3 nm is used as the CO₂ adsorbent 102b. In the high specific surface area material, it is desirable that as many pores as possible exceed the molecular diameter of O₂, the molecular diameter of CO₂, and the ion diameter of the electrolytic solution 106, and it is most desirable that all pores exceed the molecular diameter of O₂, the molecular diameter of CO₂, and the ion diameter of the electrolytic solution 106.

When the pore diameter of the high specific surface area material is too large, the specific surface area decreases, and the CO₂ adsorption efficiency decreases. Therefore, the pore diameter of the high specific surface area material used as the CO₂ adsorbent 102b is desirably less than about 100 times the ion diameter of the electrolytic solution 106.

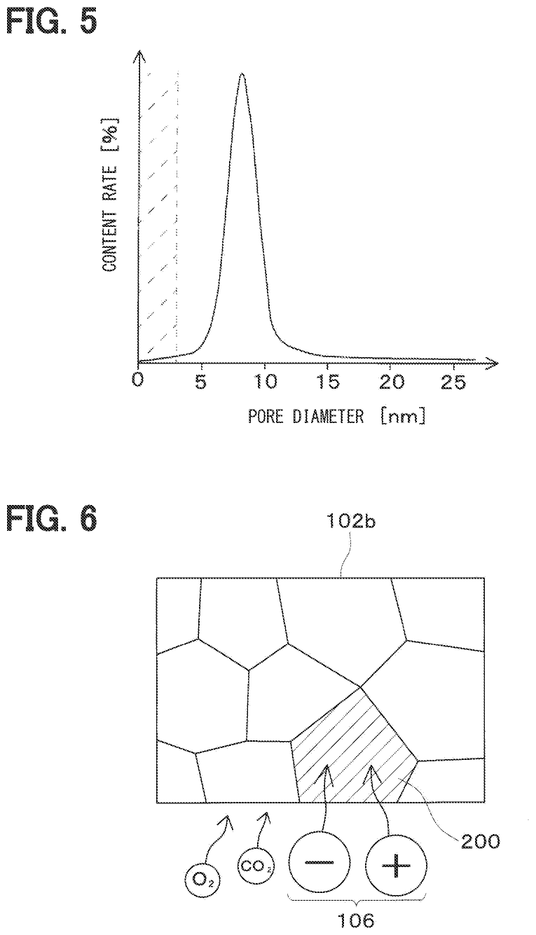

FIG. 5 shows an example of the pore diameter distribution of the high specific surface area material used as the CO₂ adsorbent 102b. A portion hatched with oblique lines in FIG. 5 corresponds to the molecular diameter of O₂, the molecular diameter of CO₂, and the ion diameter of the ionic liquid used as the CO₂ adsorbent 102b. In the example shown in FIG. 5, most of the pore diameters of the high specific surface area material exceed the molecular diameter of O₂, the molecular diameter of CO₂, and the ion diameter of the electrolytic solution 106.

The pore diameter of the high specific surface area material used as the CO₂ adsorbent 102b is desirably within a predetermined range exceeding the molecular diameter of O₂, the molecular diameter of CO₂, and the ion diameter of the electrolytic solution 106. In the example shown in FIG. 5, most of the pore diameter of the high specific surface area material falls within a predetermined range (for example, 5 to 12 nm).

In the present embodiment, mesoporous carbon is used as the high specific surface area material constituting the CO₂ adsorbent 102b. Mesoporous carbon is a mesoporous material having a pore diameter of 2 to 50 nm.

In FIG. 6, the pores 200 of the CO₂ adsorbent 102b are enlarged and schematically shown, and the cations of the electrolytic solution 106 are indicated by “+”, and the anions are indicated by “−”. In FIG. 6, the solid line indicates the wall surfaces of the pores 200, and each portion surrounded by the solid line indicates the pore 200. In FIG. 6, as an example, a hatched portion is denoted by a reference numeral and is illustrated as the pore 200. As shown in FIG. 6, in the CO₂ adsorbent 102b of the present embodiment, O₂, CO₂, and ions contained in the electrolytic solution 106 can easily enter and diffuse into the pores 200.

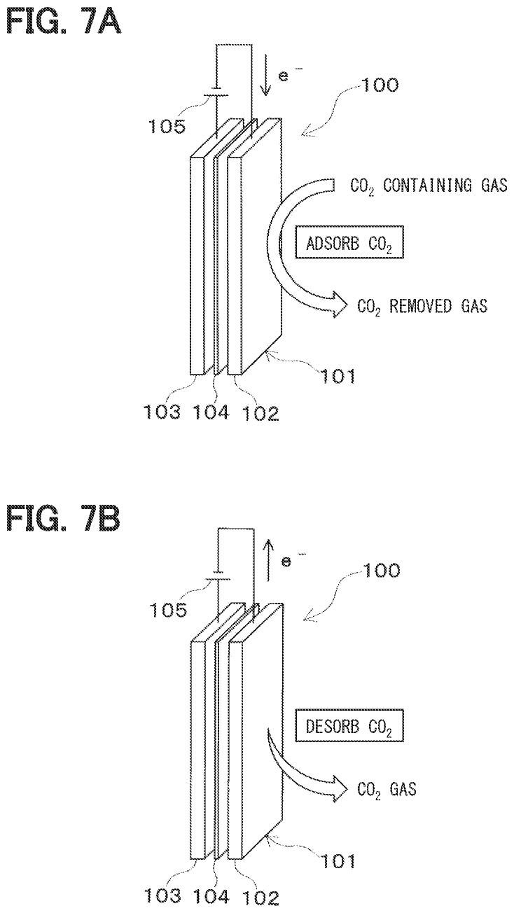

Next, an operation of the carbon dioxide recovery system 10 of the present embodiment will be described. The carbon dioxide recovery system 10 operates by alternately switching between the CO₂ recovery mode shown in FIG. 7A and the CO₂ discharge mode shown in FIG. 7B. The operation of the carbon dioxide recovery system 10 is controlled by the controller 14.

First, the CO₂ recovery mode will be described. In the CO₂ recovery mode, the compressor 11 operates to supply CO₂ containing gas to the CO₂ recovery device 100. In the CO₂ recovery device 100, a voltage applied between the working electrode 102 and the counter electrode 103 is set to the first voltage V1. As a result, the counter-electrode active material 103b of the counter electrode 103 discharges electrons to be oxidized, and the electrons are supplied from the counter electrode 103 to the working electrode 102.

In the working electrode 102, the oxygen reduction reaction in which active oxygen O₂⁻ is generated from O₂ contained in the CO₂ containing gas and the carbonate ion generation reaction in which CO₂ contained in the CO₂ containing gas is oxidized by the active oxygen O₂⁻ to generate carbonate ions CO₃²⁻ proceed.

Since the CO₂ adsorbent 102b of the present embodiment has the pore diameter larger than the molecular diameter of O₂, the molecular diameter of CO₂, and the ion diameter of the electrolytic solution 106, O₂, CO₂, and ions of the electrolytic solution 106 sufficiently diffuse into the pores of the CO₂ adsorbent 102b. Accordingly, the ratio of the effective active sites in the CO₂ adsorbent 102b can be increased, and the progress of the oxygen reduction reaction and the carbonate ion generation reaction can be promoted.

CO₂ contained in the CO₂ containing gas is efficiently adsorbed by the CO₂ adsorbent 102b. Thus, the CO₂ recovery device 100 can recover CO₂ from the CO₂ containing gas.

After the CO₂ is recovered by the CO₂ recovery device 100, the CO₂ removed gas is discharged from the CO₂ recovery device 100. The passage switching valve 12 switches the passage of exhaust gas toward the atmosphere, and the CO₂ removed gas from the CO₂ recovery device 100 is discharged to the atmosphere.

Next, the CO₂ discharge mode will be described. In the CO₂ discharge mode, the compressor 11 is stopped and supply of the CO₂ containing gas to the CO₂ recovery device 100 is stopped. In the CO₂ recovery device 100, a voltage applied between the working electrode 102 and the counter electrode 103 is set to the second voltage V2. As a result, electron donation of the CO₂ adsorbent 102b of the working electrode 102 and electron attraction of the counter-electrode active material 103b of the counter electrode 103 can be realized at the same time. The counter-electrode active material 103b of the counter electrode 103 receives electrons to be reduced.

The CO₂ adsorbent 102b of the working electrode 102 discharges electrons. By discharging the electrons, the CO₂ adsorbent 102b desorbs adsorbed CO₂. In the CO₂ discharge mode, a carbonate ion dissociation reaction progresses in which the carbonate ion CO₃²⁻ adsorbed on the CO₂ adsorbent 102b of the working electrode 102 dissociates into CO₂. As a result, the CO₂ is desorbed from the CO₂ adsorbent 102b.

The CO₂ from the CO₂ adsorbent 102b is discharged from the CO₂ recovery device 100. The passage switching valve 12 switches the passage of the exhaust gas toward the CO₂ utilizing device 13, and the CO₂ discharged from the CO₂ recovery device 100 is supplied to the CO₂ utilizing device 13.

In the present embodiment described above, the porous body having the pore diameter larger than the molecular diameter of O₂, the molecular diameter of CO₂, and the ion diameter of the electrolytic solution 106 is used as the CO₂ adsorbent 102b. Therefore, in the CO₂ adsorption mode, O₂, CO₂, and ions of the electrolytic solution 106 can sufficiently diffuse into the pores of the CO₂ adsorbent 102b. Accordingly, the ratio of the effective active sites in the CO₂ adsorbent 102b can be increased, and the CO₂ recovery efficiency can be improved.

### Second Embodiment

The following describes a second embodiment of the present disclosure. Hereinafter, differences from the first embodiment will be described.

In the second embodiment, as the high specific surface area material constituting the CO₂ adsorbent 102b, at least one of a porous carbon material derived from a metal-organic framework as a precursor or a porous inorganic material derived from a metal-organic framework as a precursor is used. The metal-organic framework has a porous three-dimensional structure in which an organic ligand is coordinately bonded to a metal element. In the following description, the metal-organic framework is referred to as “MOF”, the porous carbon material derived from the metal-organic framework as a precursor is referred to as “MOF-derived carbon material”, and the porous inorganic material derived from the metal-organic framework as a precursor is referred to as “MOF-derived inorganic material”.

Examples of the MOF-derived carbon material are described in “Fabrication of symmetric supercapacitors based on MOF-derived nanoporous carbons”, J. Mater. Chem. A2 (2014) 19848-19854. Examples of the MOF-derived inorganic material are described in “Porous Co₃O₄ materials prepared by solid-state thermolysis of a novel Co-MOF crystal and their superior energy storage performances for supercapacitors”, J. Mater. Chem. Al (2013) 7235-7241.

As the MOF serving as the precursor of the MOF-derived carbon material, for example, at least one selected from the group consisting of ZIF-8, MOF-5, MOF-2, Zn-BTC, ZIF-69, Mg-BDC, HKUST-1, Al-PCP, and IRMOF-3 can be used. The MOF-derived carbon material includes, in a basic skeleton, a carbon element contained in the MOF as the precursor. The MOF-derived carbon material is a nanoporous carbon having nanosized pores.

The MOF-derived carbon material can be obtained by thermally decomposing the MOF as the precursor under an inert gas atmosphere such as Ar or N₂. For example, when ZIF-8 is used, a thermal decomposition temperature can be set to 1000° C.

As the MOF serving as the precursor of the MOF-derived inorganic material, for example, at least one selected from the group consisting of Co-MOF, Co-BDC, MIL-101(Cr), Ce-BTC, MOF-100, ZIF-67, and Ni-BDC can be used. The MOF-derived inorganic material includes, in a basic skeleton, a metal oxide (for example, Co₃O₄) which is an oxide of a metal element contained in the MOF.

The MOF-derived inorganic material can be obtained by firing the MOF as the precursor in air. For example, when Co-MOF is used, the heating temperature can be set to 450° C. and the heating time can be set to 2 hours.

The MOF-derived carbon material and the MOF-derived inorganic material are porous bodies having a uniform pore diameter distribution and have high conductivity. The MOF-derived carbon material has a high specific surface area, and the MOF-derived inorganic material has a high structural stability.

The MOF-derived material and the MOF-derived inorganic material have a uniform pore diameter distribution corresponding to the three-dimensional structure of the MOF as the precursor. The pore diameters of the MOF-derived carbon material and the MOF-derived inorganic material are substantially the same as the pore diameter of the MOF as the precursor. For example, the pore diameter of the ZIF-8 is about 0.7 nm, and the pore diameter of the Co-MOF is about 1 nm. The pore diameter of the MOF-derived carbon material and the MOF-derived inorganic material can be adjusted by selecting the MOF used as the precursor based on the pore diameter.

In the present second embodiment described above, at least one of the MOF-derived carbon material or the MOF-derived inorganic material derived from MOF as the precursor is used as the CO₂ adsorbent 102b. Accordingly, the pore diameter of the CO₂ adsorbent 102b can be made uniform. As a result, it is possible to restrict the CO₂ adsorbent 102b from including pores having a molecular diameter smaller than the molecular diameter of O₂, the molecular diameter of CO₂, and the ion diameter of the electrolytic solution 106, and it is possible to increase the ratio of effective active sites. Furthermore, the CO₂ adsorbent 102b can be restricted from including pores that are too large with respect to the ion diameter of the electrolytic solution 106, and a high specific surface area can be secured.

### Third Embodiment

The following describes a third embodiment of the present disclosure. Hereinafter, differences from the first embodiment will be described.

In the third embodiment, as the high specific surface area material constituting the CO₂ adsorbent 102b, a porous carbon material derived from a composite as a precursor is used, and the composite has a structure in which a metal oxide is coated with a carbon material. In the following description, a porous carbon material derived from a metal oxide as a precursor is referred to as a “metal-oxide-derived carbon material”. Examples of the metal-oxide-derived carbon material are described in “Pore structure and application of MgO-tem plated carbons”, TANSO 2010, No. 242, 60-68.

The metal-oxide-derived carbon material can be obtained by a mold carbonization method using a metal oxide as a mold. In the mold carbonization method, a composite in which a metal oxide is coated with a carbon material is subjected to acid washing, whereby the metal oxide serving as the mold is dissolved and removed, and a porous carbon material having a hollow mold portion is obtained. The acid washing can be performed using low concentration sulfuric acid. As the metal oxide included in the precursor, for example, MgO can be used. As a specific example of the metal-oxide-derived carbon material, for example, CNovel (registered trademark) of TOYO TANSO CO., LTD. can be used.

The metal-oxide-derived carbon material is a porous body having a uniform pore diameter distribution, and has a high conductivity and a high specific surface area. The metal-oxide-derived carbon material has a uniform pore diameter distribution corresponding to the particle size of the metal oxide used as the precursor. The pore diameter of the metal-oxide-derived carbon material is approximately the same as the particle size of the metal oxide. For example, the MgO particles have a particle size of about 10 to 100 nm. The pore diameter of the metal-oxide-derived carbon material can be adjusted by selecting the particle size of the metal oxide used as the precursor.

In the third embodiment described above, the metal-oxide-derived carbon material derived from the metal oxide as the precursor is used as the CO₂ adsorbent 102b. Accordingly, the pore diameter of the CO₂ adsorbent 102b can be made uniform. As a result, it is possible to restrict the CO₂ adsorbent 102b from including pores having a molecular diameter smaller than the molecular diameter of O₂, the molecular diameter of CO₂, and the ion diameter of the electrolytic solution 106, and it is possible to increase the ratio of effective active sites. Furthermore, the CO₂ adsorbent 102b can be restricted from including pores that are too large with respect to the ion diameter of the electrolytic solution 106, and a high specific surface area can be secured.

### Other Embodiments

The present disclosure is not limited to the embodiments described above, and various modifications can be made as follows within a range not departing from the spirit of the present disclosure. The means disclosed in each of the above embodiments may be appropriately combined to the extent practicable.

For example, each of the above embodiments has described an example in which the high specific surface area material that does not have a chemical structure serving as an active site for adsorbing CO₂ in the material itself is used as the CO₂ adsorbent 102b. However, such a high specific surface area material and a material having a chemical structure serving as an active site (for example, polyanthraquinone) may be simultaneously used.

What is claimed is:

1. A carbon dioxide recovery system for separating CO₂ from a CO₂ containing gas by an electrochemical reaction, the carbon dioxide recovery system comprising:
an electrochemical cell including a working electrode, a counter electrode, and an electrolytic solution, the working electrode including a CO₂ adsorbent, the working electrode and the counter electrode disposed to sandwich the electrolytic solution therebetween, wherein
the CO₂ adsorbent is configured to absorb CO₂ in response to a voltage being applied between the working electrode and the counter electrode and electrons being supplied from the counter electrode to the working electrode, and
the CO₂ adsorbent is a porous body having a plurality of pores, and a pore diameter of the plurality of pores is larger than an ion diameter of the electrolytic solution.

2. The carbon dioxide recovery system according to claim 1, wherein
the CO₂ adsorbent is mesoporous carbon.

3. The carbon dioxide recovery system according to claim 1, wherein
the CO₂ adsorbent is a porous carbon material derived from a metal-organic framework as a precursor.

4. The carbon dioxide recovery system according to claim 3, wherein
the porous carbon material is produced by thermally decomposing the metal-organic framework.

5. The carbon dioxide recovery system according to claim 3, wherein
the metal-organic framework is at least one selected from a group consisting of ZIF-8, MOF-5, MOF-2, Zn-BTC, ZIF-69, Mg-BDC, HKUST-1, Al-PCP, and IRMOF-3.

6. The carbon dioxide recovery system according to claim 1, wherein
the CO₂ adsorbent is a porous inorganic material derived from a metal-organic framework as a precursor.

7. The carbon dioxide recovery system according to claim 6, wherein
the porous inorganic material is produced by firing the metal-organic framework.

8. The carbon dioxide recovery system according to claim 6, wherein
the metal-organic framework is at least one selected from a group consisting of Co-MOF, Co-BDC, MIL-101(Cr), Ce-BTC, MOF-100, ZIF-67, and Ni-BDC.

9. The carbon dioxide recovery system according to claim 1, wherein
the CO₂ adsorbent is a porous carbon material derived from a composite as a precursor, and
the composite has a structure in which a metal oxide is coated with a carbon material.

10. The carbon dioxide recovery system according to claim 9, wherein
the porous carbon material is produced by removing the metal oxide from the composite.

11. The carbon dioxide recovery system according to claim 9, wherein
the metal oxide is MgO.
